(19) United States
(12) Patent Application Publication
(10) Pub. No.: US 2026/0211719 A1
(43) Pub. Date: Jul. 23, 2026

(54) MODEL CHECKPOINT SAVING BASED ON MULTI-TIER STORAGE

(71) Applicant: Microsoft Technology Licensing, LLC, Redmond, WA (US)

(72) Inventors: Wei LUO, Redmond, WA (US); Xiaoran LI, Redmond, WA (US); Yang QIU, Redmond, WA (US); Chengcheng GUO, Redmond, WA (US); Qinghuan RAO, Redmond, WA (US); Jiapeng LI, Redmond, WA (US); Aonan ZHAI, Redmond, WA (US); Xiaole WEN, Redmond, WA (US); Yang YANG, Redmond, WA (US); Peng WANG, Redmond, WA (US); Ziqi WANG, Redmond, WA (US); Guoliang HUA, Redmond, WA (US); Shanming XUAN, Redmond, WA (US); Jie TONG, Beijing (CN)

(21) Appl. No.: 19/137,613

(22) PCT Filed: Mar. 5, 2024
(86) PCT No.: PCT/US2024/018453

§ 371 Date: Jun. 10, 2025

(30) Foreign Application Priority Data
Mar. 14, 2023 (CN) 202310246286.0

(51) Int. Cl. G06F 9/48; G06N 20/00

(52) U.S. Cl. CPC G06F 9/485; G06N 20/00

(57) ABSTRACT

The present disclosure proposes a method, apparatus, and computer-readable medium for model checkpoint saving based on multi-tier storage. During a training of a machine learning model performed through a Graphics Processing Unit (GPU) in a target node, a checkpoint to be saved of the machine learning model may be identified from a GPU memory that directly exchanges data with the GPU. The checkpoint may be saved from the GPU memory to a central processing unit (CPU) memory that directly exchange data with a CPU in the target node. The checkpoint may be saved from the CPU memory to a non-transitory memory, the non-transitory memory including at least one of: a local non-transitory memory in the target node, a neighbor non-transitory memory in a neighbor node of the target node, and a remote non-transitory memory located remotely from the target node.

### BACKGROUND

With the growth of the computing data volume and the improvement of computing power, machine learning has been widely applied in various fields. A variety of machine learning models have been developed continually, and have performed outstandingly in many areas such as natural language processing, computer vision, etc. For example, a Bidirectional Encoder Representations from Transformers (BERT) model, a Generative Pre-trained Transformer-3 (GPT-3) model, etc., have been proved to have excellent results in the field of natural language processing. Such models are often large-scale or ultra-large-scale deep learning models that rely on deep networks with huge number of parameters. Training such models is usually very time-consuming.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure present a method, apparatus, and computer readable medium for model checkpoint saving based on multi-tier storage. During a training of a machine learning model performed through a Graphics Processing Unit (GPU) in a target node, a checkpoint to be saved of the machine learning model may be identified from a GPU memory that directly exchanges data with the GPU. The checkpoint may be saved from the GPU memory to a central processing unit (CPU) memory that directly exchange data with a CPU in the target node. The checkpoint may be saved from the CPU memory to a non-transitory memory, the non-transitory memory including at least one of: a local non-transitory memory in the target node, a neighbor non-transitory memory in a neighbor node of the target node, and a remote non-transitory memory located remotely from the target node.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary process for model checkpoint saving based on multi-tier storage according to an embodiment of the present disclosure.

FIG. 2 illustrates a first example of a process for model checkpoint saving based on multi-tier storage according to an embodiment of the present disclosure.

FIG. 3 illustrates a second example of a process for model checkpoint saving based on multi-tier storage according to an embodiment of the present disclosure.

FIG. 4 illustrates a third example of a process for model checkpoint saving based on multi-tier storage according to an embodiment of the present disclosure.

FIG. 5 illustrates a fourth example of a process for model checkpoint saving based on multi-tier storage according to an embodiment of the present disclosure.

FIG. 6 illustrates a fifth example of a process for model checkpoint saving based on multi-tier storage according to an embodiment of the present disclosure.

FIG. 7 illustrates a sixth example of a process for model checkpoint saving based on multi-tier storage according to an embodiment of the present disclosure.

FIG. 8 is a flowchart of an exemplary method for model checkpoint saving based on multi-tier storage according to an embodiment of the present disclosure.

FIG. 9 illustrates an exemplary apparatus for model checkpoint saving based on multi-tier storage according to an embodiment of the present disclosure.

FIG. 10 illustrates another exemplary apparatus for model checkpoint saving based on multi-tier storage according to an embodiment of the present disclosure.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

Training of a machine learning model may be performed collaboratively by a set of machines. Herein, a machine used to perform training of a machine learning model is referred to as a node. Each node may contain several Graphics Processing Units (GPUs). The training of the machine learning model may be performed in respective GPU. The training process of the machine learning model is usually very long, especially for an ultra-large-scale deep learning model. Inevitably, during the training of the machine learning model, the training process may be interrupted due to node failure and other reasons. In order to resume the training process after an interruption of the training process, states of the machine learning model may be saved during the training. The states of the machine learning model saved during the training of the machine learning model may be referred to as a checkpoint of the machine learning model. Currently, a checkpoint created at a node is usually saved directly from a GPU memory of the node to a final memory, e.g., saved directly to a hard disk of the node or to a memory located remotely from the node. This process may occupy a lot of GPU resources; therefore, model training and model checkpoint saving cannot be performed simultaneously. For example, after completing each phase of training, it needs to pause the training before saving the model checkpoint at the current moment. Subsequently, the training of the model may be continued only after model checkpoint saving is completed. However, model checkpoint saving often takes a long time, especially for a large-scale or an ultra-large-scale deep learning model. Therefore, an overhead incurred in the model checkpoint saving process is significant and may greatly increase a time required to complete the model training. The overhead incurred in the model checkpoint saving process may be reduced by decreasing the number of times of model checkpoint saving, i.e., increasing a time interval between two adjacent model checkpoint savings. However, when the model training process is interrupted and it needs to use the last saved checkpoint to resume the training process, a longer training process will be lost if the time interval between two adjacent model checkpoint savings is too long. This also results in a large waste of training resources.

Embodiments of the present disclosure propose model checkpoint saving based on multi-tier storage. For example, during a training of a machine learning model performed through a GPU in a target node, a checkpoint to be saved of the machine learning model may be identified from a GPU memory that directly exchanges data with the GPU. Herein, a target node refers to a node for which model checkpoint saving is to be performed. Usually, the GPU memory is a transitory memory. Then, the checkpoint may be saved from the GPU memory to a Central Processing Unit (CPU) memory that directly exchanges data with a CPU in the target node. Usually, the CPU memory is a transitory memory. Herein, the checkpoint saving process whose destination is a CPU memory is referred to as tier-one storage. The data transfer from the GPU memory to the CPU memory can achieve a high speed. Thus, the checkpoint can be quickly saved from the GPU memory to the CPU memory. The tier-one storage is usually performed after each phase of model training is completed, but since it only takes up a very small amount of time, a next phase of model training can be started in a very short period of time.

After the checkpoint is saved to the CPU memory, the checkpoint may be saved from the CPU memory to a local non-transitory memory in the target node and/or a neighbor non-transitory memory in a neighbor node of the target node. Herein, a non-transitory memory in a target node is referred to a local non-transitory memory of the target node. A neighbor node of a target node is a node that is located in the same cluster as the target node and its IP address is close to an IP address of the target node or its index in the cluster is close to an index of the target node. The following takes a cluster containing N nodes as an example to illustrate the neighbor node. An index of each node in the cluster may be i (0≤i≤N−1). When the index of the target node in the cluster is i∈[0,N−2], its neighbor node may be a node located in the same cluster and its index in the cluster is i+1. When the index of the target node in the cluster is i=N−1, its neighbor node may be a node located in the same cluster and its index in the cluster is 0. It should be appreciated that the target node and the neighbor node are relative to each other. When model checkpoint saving is to be performed for the neighbor node, the neighbor node becomes the target node. Herein, a non-transitory memory located in a neighbor node of a target node may be referred to a neighbor non-transitory memory of the target node. The checkpoint saving process whose destination is a local non-transitory memory and/or a neighbor non-transitory memory may be referred to as tier-two storage. The process for saving the checkpoint from the CPU memory to the local non-transitory memory and/or the neighbor non-transitory memory can be performed in the background of the model training. Thus, the model training and the tier-two storage can be performed simultaneously.

Subsequently, the checkpoint may be saved from the local non-transitory memory and/or the neighbor non-transitory memory to a remote non-transitory memory located remotely from the target node. The remote non-transitory memory may be, e.g., a non-transitory memory located in the cloud. The remote non-transitory memory may be designed to save checkpoints created at one or more clusters. Herein, the checkpoint saving process whose destination is a remote non-transitory memory is referred to as tier-three storage. The process for saving the checkpoint from the local non-transitory memory and/or the neighbor non-transitory memory to the remote non-transitory memory can also be performed in the background of the model training. Thus, the model training and the tier-three storage can be performed simultaneously.

The above technical solution employs a plurality of processes including the tier-one storage, the tier-two storage, and the tier-three storage to save the checkpoint of the machine learning model, and thus may be referred to as model checkpoint saving based on multi-tier storage.

The tier-one storage, the tier-two storage, and the tier-three storage can all be performed at a fast rate, and thus a fast model checkpoint saving can be achieved. In addition, both of the tier-two storage and the tier-three storage can be performed simultaneously with the model training, and thus the model training can be accelerated, which is particularly beneficial for large-scale or ultra-large-scale deep learning models. Moreover, a CPU memory or a non-transitory memory in respective node is usually underutilized during the training of a machine learning model. The above process utilizes an available space in the CPU memory or the non-transitory memory of the node to save a checkpoint, which can improve the resource utilization, and thus reduce the resource overhead incurred in the model checkpoint saving.

Saving a checkpoint from a GPU memory to a CPU memory through tier-one storage enables a training process to be resumed with the checkpoint saved in the CPU memory when the training process executed at a GPU of a target node fails. Saving the checkpoint from the CPU memory to a neighbor non-transitory memory through tier-two storage enables the training process to be resumed with the checkpoint saved in the neighbor non-transitory memory when the target node fails. Saving the checkpoint from the local non-transitory memory and/or the neighbor non-transitory memory to a remote non-transitory memory through tier-three storage enables the training process to be resumed with the checkpoint saved in the remote non-transitory memory when the entire training task fails or the entire cluster fails. Thus, the model checkpoint saving based on multi-tier storage can implement tiered resuming mechanism. In contrast, in the prior art, a checkpoint created at a node is saved directly from a GPU memory of the node to a final memory. Therefore, regardless of the tier of failure or fault, it needs to retrieve the checkpoint from the final memory. Therefore, the model checkpoint saving based on multi-tier storage provides a more flexible resuming measure compared to the prior art, can resume the training process in a shorter period of time, and thereby improves the stability of the model training. In addition, when performing checkpoint saving through each tier storage, since the incurred overhead is small, the model training is not affected, and other reasons, a time interval between two adjacent checkpoint savings can be shortened, and can be set according to actual application requirements. This can reduce the lost training process and decrease the waste of training resources when the model training process is interrupted.

The above technical solution of model checkpoint saving based on multi-tier storage is not limited to any particular machine learning platform for providing computational and storage resources required for machine learning, and thus can operate on various machine learning platforms. In addition, the technical solution does not rely on any specific machine learning framework for providing a machine learning tool, and thus can be compatible with various machine learning frameworks.

It should be appreciated that although the foregoing discussion and the following discussion may involve the use of all three of the tier-one storage, the tier-two storage, and the tier-three storage to perform model checkpoint saving, the embodiments of the present disclosure are not limited to this. Depending on actual application requirements, it is also possible to perform model checkpoint saving using only any one or two of the tier-one storage, the tier-two storage, and the tier-three storage.

Various embodiments of the present disclosure will hereinafter be described in connection with the appended drawings.

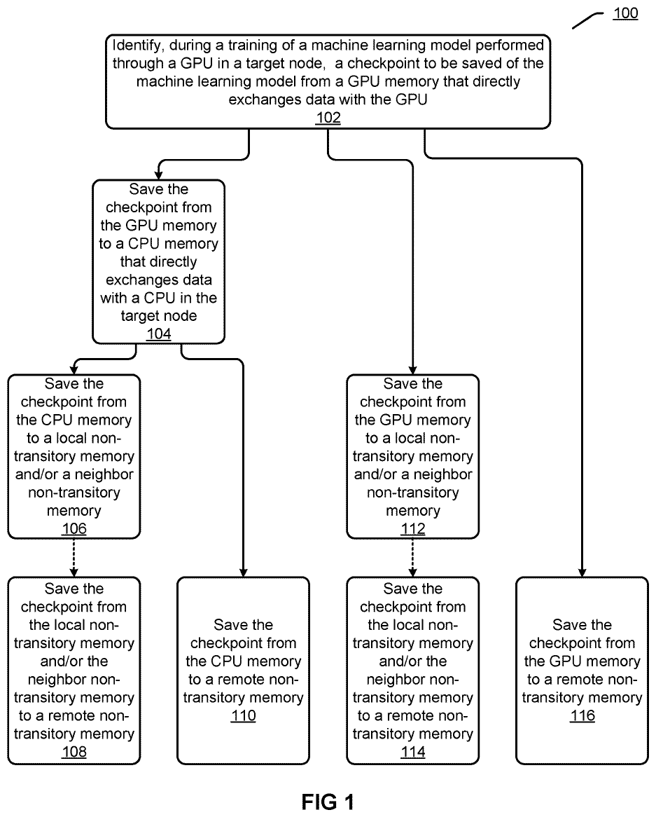

FIG. 1 illustrates an exemplary process 100 for model checkpoint saving based on multi-tier storage according to an embodiment of the present disclosure.

At 102, during a training of a machine learning model performed through a GPU in a target node, a checkpoint to be saved of the machine learning model may be identified from a GPU memory that directly exchanges data with the GPU. Usually, the GPU memory is a transitory memory. The checkpoint to be saved of the machine learning model may be created during the training of the machine learning model, and may include model states at the current moment, such as parameters, gradients, optimizer states, etc. of the model. The optimizer states may include, e.g., momentum, variances, parameters with a 32-bit floating-point precision, gradients with a 32-bit floating-point precision, etc.

At 104, the checkpoint may be saved from the GPU memory to a CPU memory that exchanges data directly with a CPU in the target node. Usually, the CPU memory is a transitory memory. The process may be considered as tier-one storage. The checkpoint may be retained in the CPU memory for a period of time, so that a training process can be quickly resumed with the checkpoint retained in the CPU memory when the training process is interrupted. The CPU may also be used to perform the training of the machine learning model. In this case, the checkpoint may be saved to the CPU memory through memory copy. The data transfer from the GPU memory to the CPU memory can achieve a high speed. For example, usually, the throughput from the GPU memory to the CPU memory can reach more than 10 GB/s. Thus, the checkpoint can be quickly saved from the GPU memory to the CPU memory. The tier-one storage is usually performed after each phase of model training is completed, but since it only takes up a very small amount of time, a next phase of model training can be started in a very short period of time.

Subsequently, the checkpoint may be saved from the CPU memory to a non-transitory memory. The non-transitory memory may be a hard disk, such as a hard disk conforming to a Non-Volatile Memory Express (NVMe) specification. The non-transitory memory may include, e.g., a local non-transitory memory in the target node, a neighbor non-transitory memory located in a neighbor node of the target node, a remote non-transitory memory located remotely from the target node, etc.

In an implementation, after performing the step 104, at 106, the checkpoint may be saved from the CPU memory to the local non-transitory memory and/or the neighbor non-transitory memory. This process may be considered as tier-two storage. The data transfer from the CPU memory to the local non-transitory memory and/or the neighbor non-transitory memory can achieve a high speed. For example, usually, the throughput from the CPU memory to the local non-transitory memory and/or the neighbor non-transitory memory can reach more than 5 GB/s. Therefore, the checkpoint can be saved quickly from the CPU memory to the local non-transitory memory and/or the neighbor non-transitory memory. The process for saving the checkpoint from the CPU memory to the local non-transitory memory and/or the neighbor non-transitory memory can be performed in the background of the model training. Thus, the model training and the tier-two storage can be performed simultaneously. The local non-transitory memory and/or the neighbor non-transitory memory may be a final memory for the checkpoint. In this approach, the checkpoint may be saved through the tier-one storage and the tier-two storage. Alternatively, the local non-transitory memory and/or the neighbor non-transitory memory may also be an intermediate memory for the checkpoint. In this case, the checkpoint may be further saved to a remote non-transitory memory. For example, optionally, at 108, the checkpoint may be saved from the local non-transitory memory and/or the neighbor non-transitory memory to the remote non-transitory memory. At this point, the remote non-transitory memory may be the final memory for the checkpoint. This process may be considered as tier-three storage. In this approach, the checkpoint may be saved through the tier-one storage, the tier-two storage, and the tier-three storage. Usually, the throughput from the local non-transitory memory and/or the neighbor non-transitory memory to the remote non-transitory memory may be 0.1~1 GB/s. The process for saving the checkpoint from the local non-transitory memory and/or the neighbor non-transitory memory to the remote non-transitory memory may also be performed in the background of the model training. Thus, the model training and the tier-three storage can also be performed simultaneously.

In another implementation, after performing the step 104, at 110, the checkpoint may be saved from the CPU memory to the remote non-transitory memory. In this approach, the checkpoint may be saved through the tier-one storage and the tier-three storage. That is, after performing the tier-one storage, the tier-two storage may be skipped, and the tier-three storage may be performed directly.

The space of the CPU memory is usually limited. Preferably, a previously-saved checkpoint in the CPU memory may be periodically deleted. This may ensure that the available space in the CPU memory is sufficient to accommodate the checkpoint to be saved at any moment, thus allowing the tier-one storage to be performed smoothly. Alternatively, it may also be determined whether the available space in the CPU memory is sufficient to accommodate the checkpoint before saving the checkpoint from the GPU memory to the CPU memory. If it is determined that the available space of the CPU memory is sufficient to accommodate the checkpoint, then the checkpoint may be saved from the GPU memory to the CPU memory. If it is determined that the available space of the CPU memory is not sufficient to accommodate the checkpoint, then the checkpoint may be saved from the GPU memory to a non-transitory memory. That is, the tier-one storage may be not performed. The non-transitory memory may include, e.g., a local non-transitory memory, a neighbor non-transitory memory, a remote non-transitory memory, etc.

In an implementation, after performing the step 102, if it is determined that the available space of the CPU memory is not sufficient to accommodate the checkpoint, then the process 100 may proceed to 112. At 112, the checkpoint may be saved from the GPU memory to the local non-transitory memory and/or the neighbor non-transitory memory. The CPU memory may be used as a transfer intermediary to save the checkpoint in batches to the local non-transitory memory and/or the neighbor non-transitory memory. For example, firstly, a portion of the checkpoint may be transferred from the GPU memory to the CPU memory. Then, the CPU memory may further transfer the portion of the checkpoint to the local non-transitory memory and/or the neighbor non-transitory memory. After the CPU memory transfers the portion of the checkpoint to the local non-transitory memory and/or the neighbor non-transitory memory, the portion of the checkpoint may be deleted from the CPU memory. Subsequently, the GPU memory may transfer a next portion of the checkpoint to the CPU memory. The CPU memory may transfer the next portion of the checkpoint to the local non-transitory memory and/or the neighbor non-transitory memory in the manner described above, and so on. The operation at 112 may be considered as tier-two storage. The local non-transitory memory and/or the neighbor non-transitory memory may be the final memory for the checkpoint. In this approach, the checkpoint may be stored through the tier-two storage. Alternatively, the local non-transitory memory and/or the neighbor non-transitory memory may be the intermediate memory for the checkpoint. In this case, the checkpoint may be further saved to a remote non-transitory memory. For example, optionally, at 114, the checkpoint may be saved from the local non-transitory memory and/or the neighbor non-transitory memory to the remote non-transitory memory. At this point, the remote non-transitory memory may be the final memory for the checkpoint. This process may be considered as the tier-three storage. In this approach, the checkpoint may be saved through the tier-two storage and the tier-three storage.

In another implementation, after performing the step 102, if it is determined that the available space of the CPU memory is not sufficient to accommodate the checkpoint, then the process 100 may proceed to 116. At 116, the checkpoint may be saved from the GPU memory to the remote non-transitory memory. Similar to the step 112, the CPU memory may be used as a transfer intermediary to save the checkpoint in batches to the remote non-transitory memory. For example, firstly, a portion of the checkpoint may be transferred from the GPU memory to the CPU memory. The CPU memory may further transfer the portion of the checkpoint to the remote non-transitory memory. After the CPU memory transfers the portion of the checkpoint to the remote non-transitory memory, the portion of the checkpoint may be deleted from the CPU memory. Subsequently, the GPU memory may transfer a next portion of the checkpoint to the CPU memory, and the CPU memory may transfer the next portion of the checkpoint to the remote non-transitory memory in the manner described above, and so on. In this approach, the checkpoint may be saved through the tier-three storage. That is, the tier-one storage and the tier-two storage may be skipped, and the tier-three storage may be performed directly.

The tier-one storage at the step 104, the tier-two storage at the step 106 or the step 112, and the tier-three storage at the step 108, the step 110, the step 114, or the step 116 can all be performed at a fast rate, thus a fast model checkpoint saving can be achieved. In addition, both of the tier-two storage and the tier-three storage can be performed simultaneously with the model training, and thus the model training can be accelerated, which is particularly beneficial for large-scale or ultra-large-scale deep learning models. Moreover, a CPU memory or a non-transitory memory in respective node is usually underutilized during the training of a machine learning model. The above process utilizes an available space in the CPU memory or the non-transitory memory of the node to save a checkpoint, which can improve the resource utilization, and thus reduce the resource overhead incurred in the model checkpoint saving.

Saving a checkpoint from a GPU memory to a CPU memory through tier-one storage enables a training process to be resumed with the checkpoint saved in the CPU memory when the training process executed at a GPU of a target node fails. Saving the checkpoint from the CPU memory to a neighbor non-transitory memory through tier-two storage enables the training process to be resumed with the checkpoint saved in the neighbor non-transitory memory when the target node fails. Saving the checkpoint from the local non-transitory memory and/or the neighbor non-transitory memory to a remote non-transitory memory through tier-three storage enables the training process to be resumed with the checkpoint saved in the remote non-transitory memory when the entire training task fails or the entire cluster fails. Thus, the model checkpoint saving based on multi-tier storage can implement tiered resuming mechanism. In contrast, in the prior art, a checkpoint created at a node is saved directly from a GPU memory of the node to a final memory. Therefore, regardless of the tier of failure or fault, it needs to retrieve the checkpoint from the final memory. Therefore, the model checkpoint saving based on multi-tier storage provides a more flexible resuming measure compared to the prior art, can resume the training process in a shorter period of time, and thereby improves the stability of the model training. In addition, when performing checkpoint saving through each tier storage, since the incurred overhead is small, the model training is not affected, and other reasons, a time interval between two adjacent checkpoint savings can be shortened, and can be set according to actual application requirements. This can reduce the lost training process and decrease the waste of training resources when the model training process is interrupted.

It should be appreciated that the process described above in connection with FIG. 1 for model checkpoint saving based on multi-tier storage is merely exemplary. Depending on actual application requirements, the steps in the process for model checkpoint saving based on multi-tier storage may be replaced or modified in any manner, and the process may include more or fewer steps. For example, although multiple implementations for model checkpoint saving are illustrated in the process 100 of FIG. 1, it is possible to perform the process for model checkpoint saving using only any one or more of these implementations. Further, the specific order or hierarchy of the steps in the process 100 is merely exemplary, and the process for model checkpoint saving based on multi-tier storage may be performed in an order different from the order described.

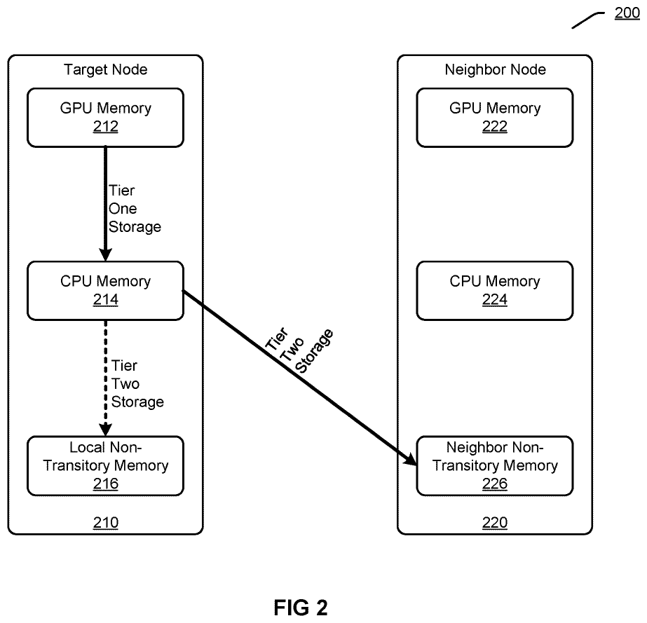

FIG. 2 illustrates a first example 200 of a process for model checkpoint saving based on multi-tier storage according to an embodiment of the present disclosure. In the first example 200, two tiers of storage including tier-one storage and tier-two storage is employed to save a checkpoint of a machine learning model created at a target node 210, such as a checkpoint created during a training of the machine learning model performed through a GPU in the target node 210. The first example 200 may correspond to the step 102 to the step 106 in FIG. 1.

A GPU memory 212 is a memory that exchanges data directly with the GPU in the target node 210. The GPU memory 212 is a transitory memory. A checkpoint to be saved of the machine learning model may be identified from the GPU memory 212.

Firstly, the checkpoint may be saved from the GPU memory 212 to a CPU memory 214 through tier-one storage. The CPU memory 214 may be a memory that exchanges data directly with a CPU in the target node 210. The CPU memory 214 is a transitory memory.

Next, the checkpoint may be saved from the CPU memory 214 to a neighbor non-transitory memory 226 in a neighbor node 220 through tier-two storage. The neighbor node 220 may also contain a GPU memory 222 and a CPU memory 224. The GPU memory 222 and the CPU memory 224 may be used to perform a checkpoint saving process of a machine learning model created at the neighbor node 220. Optionally, the checkpoint may be saved from the CPU memory 214 to a local non-transitory memory 216 in the target node 210 through tier-two storage.

In the first example 200, the local non-transitory memory 216 and/or the neighbor non-transitory memory 226 may be a final memory used to save the checkpoint created at the target node 210.

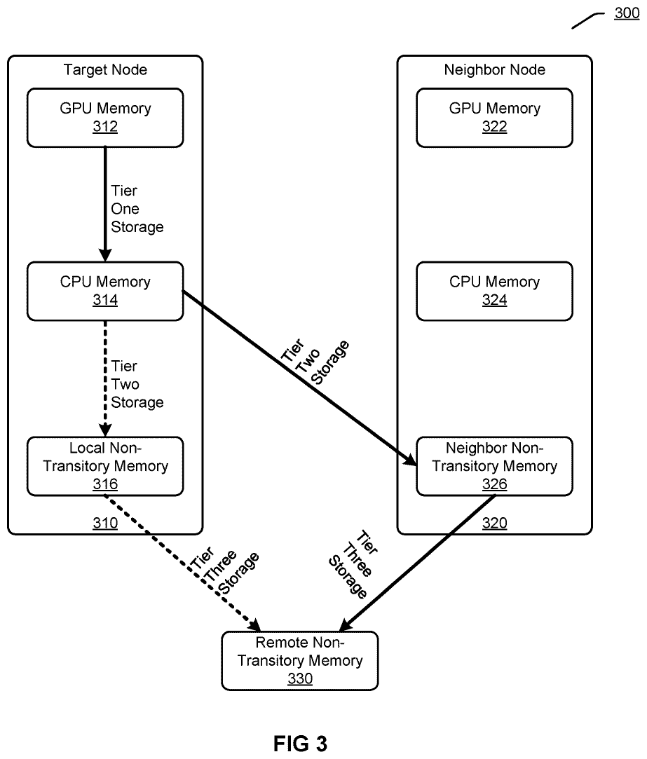

FIG. 3 illustrates a second example 300 of a process for model checkpoint saving based on multi-tier storage according to an embodiment of the present disclosure. In the second example 300, three tiers of storage including tier-one storage, tier-two storage, and tier-three storage is employed to save a checkpoint of a machine learning model created at a target node 310. The second example 300 may correspond to the step 102 to the step 108 in FIG. 1. The target node 310, a GPU memory 312, a CPU memory 314, and a local non-transitory memory 316 may correspond to the target node 210, the GPU memory 212, the CPU memory 214, and the local non-transitory memory 216, respectively, in FIG. 2. A neighbor node 320, a GPU memory 322, a CPU memory 324, and a neighbor non-transitory memory 326 may correspond to the neighbor node 220, the GPU memory 222, the CPU memory 224, and the neighbor non-transitory memory 226, respectively, in FIG. 2.

A checkpoint to be saved of a machine learning model may be identified from the GPU memory 312.

Firstly, the checkpoint may be saved from the GPU memory 312 to the CPU memory 314 through tier-one storage.

Next, the checkpoint may be saved from the CPU memory 314 to the neighbor non-transitory memory 326 in the neighbor node 320 through tier-two storage. Optionally, the checkpoint may be saved from the CPU memory 314 to the local non-transitory memory 316 in the target node 310 through tier-two storage.

Subsequently, the checkpoint may be saved from the neighbor non-transitory memory 326 to a remote non-transitory memory 330 through tier-three storage. In the case that the checkpoint is saved to the local non-transitory memory 316, the checkpoint may also be saved from the local non-transitory memory 316 to the remote non-transitory memory 330 through tier-three storage.

In the second example 300, the remote non-transitory memory 330 may be a final memory for saving the checkpoint created at the target node 310.

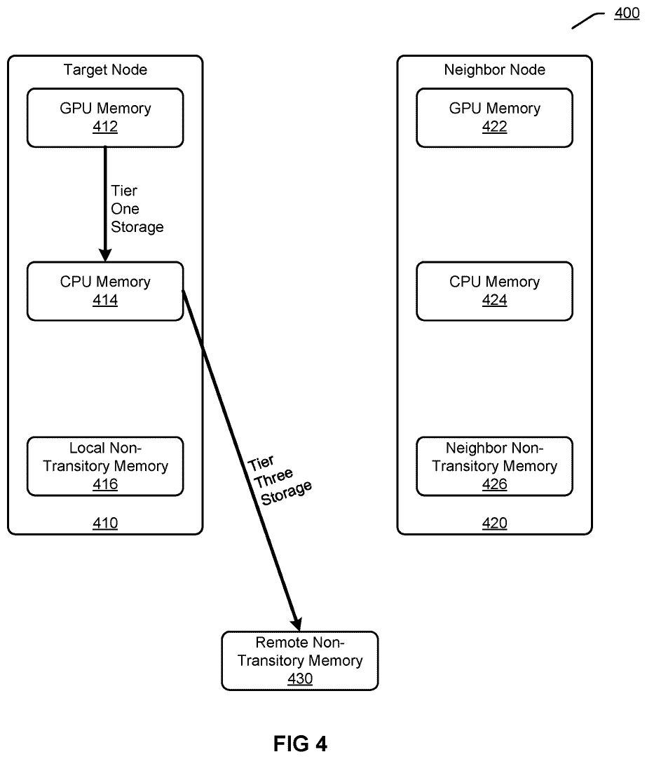

FIG. 4 illustrates a third example 400 of a process for model checkpoint saving based on multi-tier storage according to an embodiment of the present disclosure. In the third example 400, two tiers of storage including tier-one storage and tier-three storage is employed to save a checkpoint of a machine learning model created at a target node 410. The third example 400 may correspond to the step 102 to the step 104 and the step 110 in FIG. 1. The target node 410, a GPU memory 412, a CPU memory 414, and a local non-transitory memory 416 may correspond to the target node 210, the GPU memory 212, the CPU memory 214, and the local non-transitory memory 216, respectively, in FIG. 2. A neighbor node 420, a GPU memory 422, a CPU memory 424, and a neighbor non-transitory memory 426 may correspond to the neighbor node 220, the GPU memory 222, the CPU memory 224, and the neighbor non-transitory memory 226, respectively, in FIG. 2.

A checkpoint to be saved of a machine learning model may be identified from the GPU memory 412.

Firstly, the checkpoint may be saved from the GPU memory 412 to the CPU memory 414 through tier-one storage.

Next, the checkpoint may be saved from the CPU memory 414 to a remote non-transitory memory 430 through tier-three storage.

In the third example 400, the remote non-transitory memory 430 may be a final memory used to save the checkpoint created at the target node 410. In addition, the checkpoint is saved from the CPU memory 414 to the remote non-transitory memory 430 without first being saved to the local non-transitory memory 416 or the neighbor non-transitory memory 426.

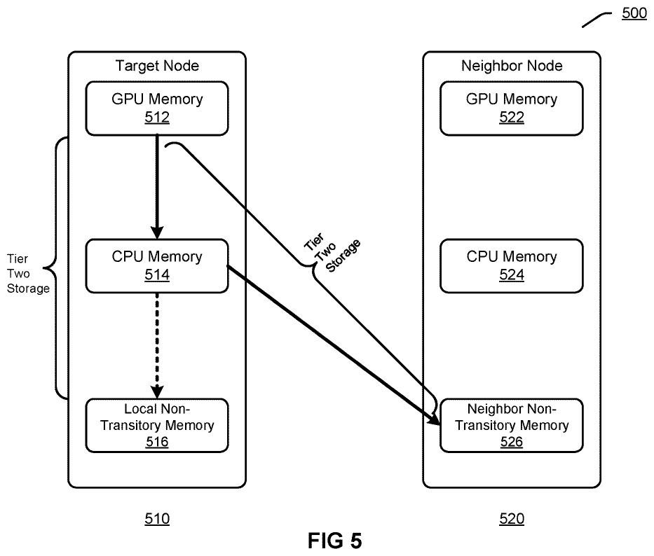

FIG. 5 illustrates a fourth example 500 of a process for model checkpoint saving based on multi-tier storage according to an embodiment of the present disclosure. In the fourth example 500, single tier of storage including tier-two storage is employed to save a checkpoint of a machine learning model created at a target node 510. The fourth example 500 may correspond to the step 102 and the step 112 in FIG. 1. The target node 510, a GPU memory 512, a CPU memory 514, and a local non-transitory memory 516 may correspond to the target node 210, the GPU memory 212, the CPU memory 214, and the local non-transitory memory 216, respectively, in FIG. 2. A neighbor node 520, a GPU memory 522, a CPU memory 524, and a neighbor non-transitory memory 526 may correspond to the neighbor node 220, the GPU memory 222, the CPU memory 224, and the neighbor non-transitory memory 226, respectively, in FIG. 2.

A checkpoint to be saved of a machine learning model may be identified from the GPU memory 512.

The CPU memory 514 may be used as a transfer intermediary to save the checkpoint in batches to the local non-transitory memory 516 and/or the neighbor non-transitory memory 526. For example, firstly, a portion of the checkpoint may be transferred from the GPU memory 512 to the CPU memory 514. The CPU memory 514 may further transfer the portion of the checkpoint to the neighbor non-transitory memory 526 in the neighbor node 520. Optionally, the CPU memory 514 may further transfer the portion of the checkpoint to the local non-transitory memory 516 in the target node 510. After the CPU memory transfers the portion of the checkpoint to the local non-transitory memory 516 and/or the neighbor non-transitory memory 526, the portion of the checkpoint may be deleted from the CPU memory 514. Subsequently, the GPU memory 512 may transfer a next portion of the checkpoint to the CPU memory 514. The CPU memory 514 may transfer the next portion of the checkpoint to the local non-transitory memory 516 and/or the neighbor non-transitory memory 526 in the manner described above, and so on. The above process may be considered as tier-two storage.

In the fourth example 500, the local non-transitory memory 516 and/or the neighbor non-transitory memory 526 may be a final memory used to save the checkpoint created at the target node 510. The fourth example 500 may be performed in a case that it is determined that the available space in the CPU memory 514 is insufficient to accommodate the checkpoint to be saved.

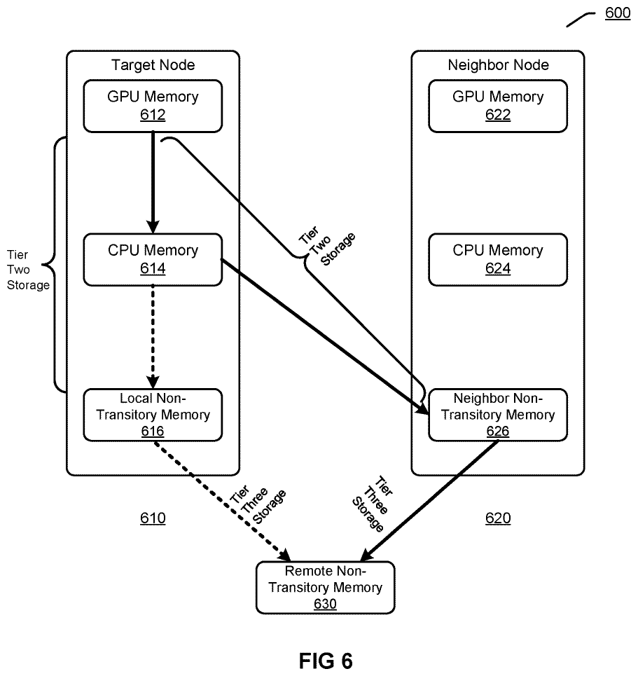

FIG. 6 illustrates a fifth example 600 of a process for model checkpoint saving based on multi-tier storage according to an embodiment of the present disclosure. In the fifth example 600, two tiers of storage including tier-two storage and tier-three storage is employed to save a checkpoint of a machine learning model created at a target node 610. The fifth example 600 may correspond to the step 102 and the step 112 to the step 114 in FIG. 1. The target node 610, a GPU memory 612, a CPU memory 614, and a local non-transitory memory 616 may correspond to the target node 210, the GPU memory 212, the CPU memory 214, and the local non-transitory memory 216, respectively, in FIG. 2. A neighbor node 620, a GPU memory 622, a CPU memory 624, and a neighbor non-transitory memory 626 may correspond to the neighbor node 220, the GPU memory 222, the CPU memory 224, and the neighbor non-transitory memory 226, respectively, in FIG. 2.

A checkpoint to be saved of a machine learning model may be identified from the GPU memory 612.

The CPU memory 614 may be used as a transfer intermediary to save the checkpoint in batches to the local non-transitory memory 616 and/or the neighbor non-transitory memory 626. For example, firstly, a portion of the checkpoint may be transferred from the GPU memory 612 to the CPU memory 614. The CPU memory 614 may further transfer the portion of the checkpoint to the neighbor non-transitory memory 626 in the neighbor node 620. Optionally, the CPU memory 614 may further transfer the portion of the checkpoint to the local non-transitory memory 616 in the target node 610. After the CPU memory transfers the portion of the checkpoint to the local non-transitory memory 616 and/or the neighbor non-transitory memory 626, the portion of the checkpoint may be deleted from the CPU memory 614. Subsequently, the GPU memory 612 may transfer a next portion of the checkpoint to the CPU memory 614. The CPU memory 614 may transfer the next portion of the checkpoint to the local non-transitory memory 616 and/or the neighbor non-transitory memory 626 in the manner described above, and so on. The above process may be considered as tier-two storage.

Next, the checkpoint may be saved from the neighbor non-transitory memory 626 to a remote non-transitory memory 630 through tier-three storage. In the case that the checkpoint is saved to the local non-transitory memory 616, the checkpoint may also be saved from the local non-transitory memory 616 to the remote non-transitory memory 630 through tier-three storage.

In the fifth example 600, the remote non-transitory memory 630 may be a final memory used to save the checkpoint created at the target node 610. The fifth example 600 may be performed in a case that it is determined that the available space in the CPU memory 614 is insufficient to accommodate the checkpoint to be saved.

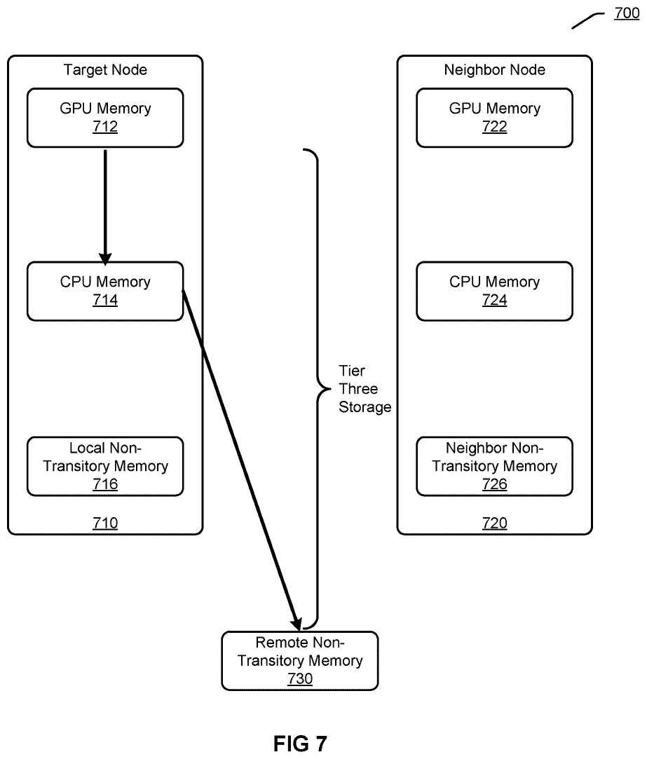

FIG. 7 illustrates a sixth example 700 of a process for model checkpoint saving based on multi-tier storage according to an embodiment of the present disclosure. In the sixth example 700, single tier of storage including tier-three storage is employed to save a checkpoint of a machine learning model created at a target node 710. The sixth example 700 may correspond to the step 102 and the step 116 in FIG. 1. The target node 710, a GPU memory 712, a CPU memory 714, and a local non-transitory memory 716 may correspond to the target node 210, the GPU memory 212, the CPU memory 214, and the local non-transitory memory 216, respectively, in FIG. 2. A neighbor node 720, a GPU memory 722, a CPU memory 724, and a neighbor non-transitory memory 726 may correspond to the neighbor node 220, the GPU memory 222, the CPU memory 224, and the neighbor non-transitory memory 226, respectively, in FIG. 2.

A checkpoint to be saved of a machine learning model may be identified from the GPU memory 712.

The CPU memory 714 may be used as a transfer intermediary to save the checkpoint in batches to the remote non-transitory memory 730. For example, firstly, a portion of the checkpoint may be transferred from the GPU memory 712 to the CPU memory 714. The CPU memory 714 may further transfer the portion of the checkpoint to the remote non-transitory memory 730. After the CPU memory transfers the portion of the checkpoint to the remote non-transitory memory 730, the portion of the checkpoint may be deleted from the CPU memory 714. Subsequently, the GPU memory 712 may transfer a next portion of the checkpoint to the CPU memory 714. The CPU memory 714 may transfer the next portion of the checkpoint to the remote non-transitory memory 730 in the manner described above, and so on. The above process may be considered as tier-three storage.

In the sixth example 700, the remote non-transitory memory 730 may be a final memory used to save the checkpoint created at the target node 710. The sixth example 700 may be performed in a case that it is determined that the available space in the CPU memory 714 is insufficient to accommodate the checkpoint to be saved.

It should be appreciated that FIG. 2 to FIG. 7 illustrate only some examples of the process for model checkpoint saving based on multi-tier storage. Depending on actual application requirements, the model checkpoint saving based on multi-tier storage may be also implemented through any other process. For example, in the example 200 to the example 700, a process for saving a checkpoint from a local non-transitory memory to a neighbor non-transitory memory is not involved. However, in some embodiments, it is possible to save a checkpoint from a local non-transitory memory to a neighbor non-transitory memory. In addition, in the example 200 to the example 700, the checkpoint created at the target node is saved to only one neighbor non-transitory memory. However, in some embodiments, it is also possible to save the checkpoint created at the target node to multiple neighbor non-transitory memories.

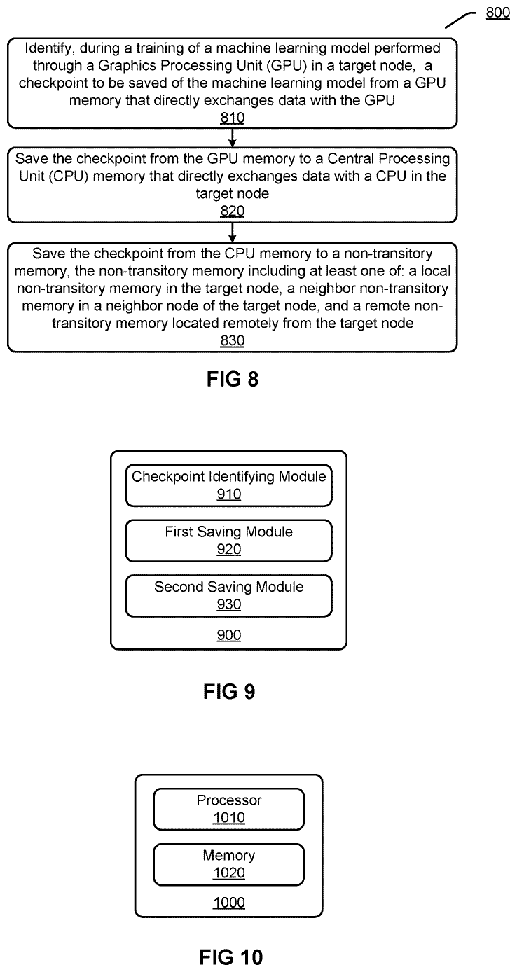

FIG. 8 is a flowchart of an exemplary method 800 for model checkpoint saving based on multi-tier storage according to an embodiment of the present disclosure.

At 810, during a training of a machine learning model performed through a Graphics Processing Unit (GPU) in a target node, a checkpoint to be saved of the machine learning model may be identified from a GPU memory that directly exchanges data with the GPU.

At 820, the checkpoint may be saved from the GPU memory to a Central Processing Unit (CPU) memory that directly exchanges data with a CPU in the target node.

At 830, the checkpoint may be saved from the CPU memory to a non-transitory memory, the non-transitory memory including at least one of: a local non-transitory memory in the target node, a neighbor non-transitory memory in a neighbor node of the target node, and a remote non-transitory memory located remotely from the target node.

In an implementation, the checkpoint to be saved of the machine learning model may include at least one of parameters, gradients and optimizer states of the machine learning model.

In an implementation, the non-transitory memory may be the local non-transitory memory and/or the neighbor non-transitory memory. The method 800 may further comprise: saving the checkpoint from the local non-transitory memory and/or the neighbor non-transitory memory to the remote non-transitory memory.

In an implementation, the method 800 may further comprise: periodically deleting a previously-saved checkpoint in the CPU memory.

In an implementation, the method 800 may further comprise: determining whether the available space of the CPU memory is sufficient to accommodate the checkpoint. Saving the checkpoint from the GPU memory to the CPU memory may be performed in response to determining that the available space of the CPU memory is sufficient to accommodate the checkpoint.

The method 800 may further comprise: saving the checkpoint from the GPU memory to the non-transitory memory in response to determining that the available space of the CPU memory is insufficient to accommodate the checkpoint. The non-transitory memory may be the local non-transitory memory and/or the neighbor non-transitory memory. The method 800 may further comprise: saving the checkpoint from the local non-transitory memory and/or the neighbor non-transitory memory to the remote non-transitory memory.

It should be appreciated that the method 800 may further comprise any step/process for model checkpoint saving based on multi-tier storage according to the embodiments of the present disclosure as mentioned above.

FIG. 9 illustrates an exemplary apparatus 900 for model checkpoint saving based on multi-tier storage according to an embodiment of the present disclosure.

The apparatus 900 may comprise: a checkpoint identifying module 910, for identifying, during a training of a machine learning model performed through a Graphics Processing Unit (GPU) in a target node, a checkpoint to be saved of the machine learning model from a GPU memory that directly exchanges data with the GPU; a first saving module 920, for saving the checkpoint from the GPU memory to a CPU memory that directly exchanges data with a Central Processing Unit (CPU) in the target node; and a second saving module 930, for saving the checkpoint from the CPU memory to a non-transitory memory, the non-transitory memory including at least one of: a local non-transitory memory in the target node, a neighbor non-transitory memory in a neighbor node of the target node, and a remote non-transitory memory located remotely from the target node. Furthermore, the apparatus 900 may further comprise any other modules configured for model checkpoint saving based on multi-tier storage according to the embodiments of the present disclosure as mentioned above.

FIG. 10 illustrates another exemplary apparatus 1000 for model checkpoint saving based on multi-tier storage according to an embodiment of the present disclosure.

The apparatus 1000 may comprise: a processor 1010; and a memory 1020 storing computer-executable instructions. The computer-executable instructions, when executed, may cause the processor 1010 to: identify, during a training of a machine learning model performed through a Graphics Processing Unit (GPU) in a target node, a checkpoint to be saved of the machine learning model from a GPU memory that directly exchanges data with the GPU; save the checkpoint from the GPU memory to a Central Processing Unit (CPU) memory that directly exchanges data with a CPU in the target node, and save the checkpoint from the CPU memory to a non-transitory memory, the non-transitory memory including at least one of: a local non-transitory memory in the target node, a neighbor non-transitory memory in a neighbor node of the target node, and a remote non-transitory memory located remotely from the target node.

In an implementation, the checkpoint to be saved of the machine learning model may comprise at least one of parameters, gradients, and optimizer states of the machine learning model.

In an implementation, the non-transitory memory may be the local non-transitory memory and/or the neighbor non-transitory memory. The computer-executable instructions, when executed, may further cause the processor 1010 to: save the checkpoint from the local non-transitory memory and/or the neighbor non-transitory memory to the remote non-transitory memory.

In an implementation, the computer-executable instructions, when executed, may further cause the processor 1010 to: periodically delete a previously-saved checkpoint in the CPU memory.

In an implementation, the computer-executable instructions, when executed, may further cause the processor 1010 to: determine whether the available space of the CPU memory is sufficient to accommodate the checkpoint. Saving the checkpoint from the GPU memory to the CPU memory is performed in response to determining that the available space of the CPU memory is sufficient to accommodate the checkpoint.

The computer-executable instructions, when executed, may further cause the processor 1010 to: save the checkpoint from the GPU memory to the non-transitory memory in response to determining that the available space of the CPU memory is insufficient to accommodate the checkpoint. The non-transitory memory may be the local non-transitory memory and/or the neighbor non-transitory memory. The computer-executable instructions, when executed, further cause the processor 1010 to: save the checkpoint from the local non-transitory memory and/or the neighbor non-transitory memory to the remote non-transitory memory.

It should be appreciated that the processor 1010 may further perform any other steps/processes of the method for model checkpoint saving based on multi-tier storage according to the embodiments of the present disclosure as mentioned above.

The embodiments of the present disclosure propose a computer program product for model checkpoint saving based on multi-tier storage, comprising a computer program that is executed by a processor for: identifying, during a training of a machine learning model performed through a Graphics Processing Unit (GPU) in a target node, a checkpoint to be saved of the machine learning model from a GPU memory that directly exchanges data with the GPU; saving the checkpoint from the GPU memory to a Central Processing Unit (CPU) memory that directly exchanges data with a CPU in the target node; and saving the checkpoint from the CPU memory to a non-transitory memory, the non-transitory memory including at least one of: a local non-transitory memory in the target node, a neighbor non-transitory memory in a neighbor node of the target node, and a remote non-transitory memory located remotely from the target node. Furthermore, the computer program may be further executed for implementing any other steps/processes of the method for model checkpoint saving based on multi-tier storage according to the embodiments of the present disclosure as mentioned above.

The embodiments of the present disclosure may be embodied in a computer-readable medium. The computer-readable medium may comprise instructions, the instructions that, when executed, cause a processor to: identify, during a training of a machine learning model performed through a Graphics Processing Unit (GPU) in a target node, a checkpoint to be saved of the machine learning model from a GPU memory that directly exchanges data with the GPU; save the checkpoint from the GPU memory to a Central Processing Unit (CPU) memory that directly exchanges data with a CPU in the target node; and save the checkpoint from the CPU memory to a non-transitory memory, the non-transitory memory including at least one of: a local non-transitory memory in the target node, a neighbor non-transitory memory in a neighbor node of the target node, and a remote non-transitory memory located remotely from the target node. Furthermore, the instructions, when executed, may also cause the processor to perform any other steps/processes of the method for model checkpoint saving based on multi-tier storage according to embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts. In addition, the articles “a” and “an” as used in this specification and the appended claims should generally be construed to mean “one” or “one or more” unless specified otherwise or clear from the context to be directed to a singular form.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured for performing the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are expressly incorporated herein and intended to be encompassed by the claims.

1. A method for model checkpoint saving based on multi-tier storage, comprising:
identifying, during a training of a machine learning model performed through a Graphics Processing Unit (GPU) in a target node, a checkpoint to be saved of the machine learning model from a GPU memory that directly exchanges data with the GPU;
saving the checkpoint from the GPU memory to a CPU memory that directly exchanges data with a Central Processing Unit (CPU) in the target node; and
saving the checkpoint from the CPU memory to a non-transitory memory, the non-transitory memory including at least one of: a local non-transitory memory in the target node, a neighbor non-transitory memory in a neighbor node of the target node, and a remote non-transitory memory located remotely from the target node.

2. The method of claim 1, wherein the checkpoint to be saved of the machine learning model includes at least one of parameters, gradients and optimizer states of the machine learning model.

3. The method of claim 1, wherein the non-transitory memory is the local non-transitory memory and/or the neighbor non-transitory memory, and the method further comprises:
saving the checkpoint from the local non-transitory memory and/or the neighbor non-transitory memory to the remote non-transitory memory.

4. The method of claim 1, further comprising:
periodically deleting a previously-saved checkpoint in the CPU memory.

5. The method of claim 1, further comprising:
determining whether the available space of the CPU memory is sufficient to accommodate the checkpoint, and
wherein saving the checkpoint from the GPU memory to the CPU memory is performed in response to determining that the available space of the CPU memory is sufficient to accommodate the checkpoint.

6. The method of claim 5, further comprising:
saving the checkpoint from the GPU memory to the non-transitory memory in response to determining that the available space of the CPU memory is insufficient to accommodate the checkpoint.

7. The method of claim 6, wherein the non-transitory memory is the local non-transitory memory and/or the neighbor non-transitory memory, and the method further comprises:
saving the checkpoint from the local non-transitory memory and/or the neighbor non-transitory memory to the remote non-transitory memory.

8. An apparatus for model checkpoint saving based on multi-tier storage, comprising:
a processor; and
a memory storing computer-executable instructions that, when executed, cause the processor to:
identify, during a training of a machine learning model performed through a Graphics Processing Unit (GPU) in a target node, a checkpoint to be saved of the machine learning model from a GPU memory that directly exchanges data with the GPU,
save the checkpoint from the GPU memory to a CPU memory that directly exchanges data with a Central Processing Unit (CPU) in the target node, and
save the checkpoint from the CPU memory to a non-transitory memory, the non-transitory memory including at least one of: a local non-transitory memory in the target node, a neighbor non-transitory memory in a neighbor node of the target node, and a remote non-transitory memory located remotely from the target node.

9. The apparatus of claim 8, wherein the checkpoint to be saved of the machine learning model includes at least one of parameters, gradients and optimizer states of the machine learning model.

10. The apparatus of claim 8, wherein the non-transitory memory is the local non-transitory memory and/or the neighbor non-transitory memory, and the computer-executable instructions, when executed, further cause the processor to:
save the checkpoint from the local non-transitory memory and/or the neighbor non-transitory memory to the remote non-transitory memory.

11. The apparatus of claim 8, wherein the computer-executable instructions, when executed, further cause the processor to:
periodically delete a previously-saved checkpoint in the CPU memory.

12. The apparatus of claim 8, wherein the computer-executable instructions, when executed, further cause the processor to:
determine whether the available space of the CPU memory is sufficient to accommodate the checkpoint, and
wherein saving the checkpoint from the GPU memory to the CPU memory is performed in response to determining that the available space of the CPU memory is sufficient to accommodate the checkpoint.

13. The apparatus of claim 12, wherein the computer-executable instructions, when executed, further cause the processor to:
save the checkpoint from the GPU memory to the non-transitory memory in response to determining that the available space of the CPU memory is insufficient to accommodate the checkpoint.

14. The apparatus of claim 13, wherein the non-transitory memory is the local non-transitory memory and/or the neighbor non-transitory memory, and the computer-executable instructions, when executed, further cause the processor to:
save the checkpoint from the local non-transitory memory and/or the neighbor non-transitory memory to the remote non-transitory memory.

15. A computer-readable medium for model checkpoint saving based on multi-tier storage, comprising instructions that, when executed, cause a processor to:
identify, during a training of a machine learning model performed through a Graphics Processing Unit (GPU) in a target node, a checkpoint to be saved of the machine learning model from a GPU memory that directly exchanges data with the GPU;
save the checkpoint from the GPU memory to a CPU memory that directly exchanges data with a Central Processing Unit (CPU) in the target node; and
save the checkpoint from the CPU memory to a non-transitory memory, the non-transitory memory including at least one of: a local non-transitory memory in the target node, a neighbor non-transitory memory in a neighbor node of the target node, and a remote non-transitory memory located remotely from the target node.
